(19) United States
(12) Patent Application Publication
(10) Pub. No.: US 2009/0059370 A1
(43) Pub. Date: Mar. 5, 2009

(54) BIREFRINGENT FILM AND METHOD OF PRODUCING THE SAME

(75) Inventors: Junzo Miyazaki, Osaka (JP); Tetsuo Inoue, Osaka (JP); Shouichi Matsuda, Osaka (JP); Tatsuki Nagatsuka, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/281,721

(22) PCT Filed: Mar. 9, 2007
(86) PCT No.: PCT/JP2007/054658

§ 371 Date: Sep. 4, 2008

(30) Foreign Application Priority Data
Apr. 27, 2006 (JP) 2006-124323
Feb. 9, 2007 (JP) 2007-030035

(51) Int. Cl. G02B 1/08; C09K 19/00

(52) U.S. Cl. 359/500; 430/20

(57) ABSTRACT

Provided is a thin birefringent film whose refractive index is three-dimensionally controlled. The present invention provides a birefringent film including at least one polycyclic compound containing a —SO₃M group and/or a —COOM group having a refractive index ellipsoid satisfying a relationship represented by nx>nz>ny, in which M represents a counter ion. Since such a birefringent film has a high in-plane refractive index, the thickness thereof is sharply reduced as compared with a conventional birefringent film and a desired retardation value can be obtained.

### TECHNICAL FIELD

The present invention relates to a thin birefringent film which contains at least one polycyclic compound including a —SO₃M group and/or a —COOM group, and whose refractive index is three-dimensionally controlled and a method of producing the thin birefringent film.

### BACKGROUND ART

A liquid crystal display (hereinafter referred to as LCD) is a device which displays a character and an image using electro-optical properties of a liquid crystal molecule, and has been widely applied to a cellular phone, a notebook computer, a liquid crystal television, etc. However, since the LCD utilizes a liquid crystal molecule with optical anisotropy, there are such problems that excellent display properties are demonstrated in a certain one direction but, in another direction, a screen becomes dark or indistinct. In order to solve the above-mentioned problems, the birefringent film has been widely employed for the LCD. Conventionally, as one kind of the birefringent film, a birefringent film in which a refractive index ellipsoid satisfies the relationship represented by nx>nz>ny is disclosed (see e.g., Patent Document 1). The birefringent film having such a relationship of refractive index is produced by attaching a shrinkable film to both sides of a polymer film, and stretching the resultant in such a manner as to expand in the thickness direction. Therefore, a conventional birefringent film is likely to increase in the thickness, which makes it difficult to reduce the thickness of the liquid crystal display. Thus, solutions for the above-mentioned problems have been desired.

### Patent Document 1: Japanese Patent Application Laid-open No. 2006-072309

### DISCLOSURE OF THE INVENTION

### Problems to be Solved by the Invention

An object of the present invention is to provide a thin birefringent film whose refractive index is three-dimensionally controlled.

### Means for Solving the Problems

In order to solve the above-mentioned problems, the inventors of the present invention conducted extensive researches. As a result, the inventors of the present invention found that the above-mentioned object can be achieved by the birefringent films described below, and thus, the present invention has been accomplished.

A birefringent film of the present invention includes at least one polycyclic compound containing a —SO₃M group and/or a —COOM group having a refractive index ellipsoid satisfying a relationship represented by nx>nz>ny, in which M represents a counter ion.

In a preferred embodiment, an in-plane birefringent index (Δn[590]) of the birefringent film at a wavelength of 590 nm is 0.05 or more.

In a preferred embodiment, a thickness of the birefringent film is 0.05 μm to 10 μm.

In a preferred embodiment, the birefringent film includes an acenaphtho[1,2-b]quinoxaline derivative represented by General Formula (I) shown below:

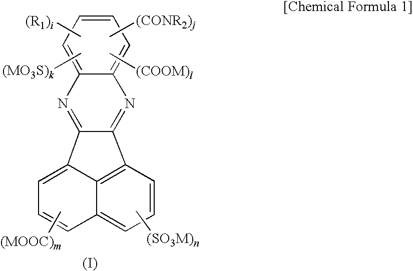

where i, j, k, and l each independently represent an integer of to 4; m and n each independently represent an integer of 0 to 6; R₁ and R₂ each represent a C₁₋₆ alkyl group; M's may be the same or different, and each M represent a counter ion; and i, j, k, l, m, and n are not simultaneously 0.

In a preferred embodiment, an in-plane retardation value (Re[590]) of the birefringent film at a wavelength of 590 nm is nm to 1000 nm.

In a preferred embodiment, a difference between an in-plane retardation value (Re[590]) and a thickness direction retardation value (Rth[590]) of the birefringent film at a wavelength of 590 nm is 10 nm to 800 nm.

In a preferred embodiment, an Nz coefficient of the birefringent film is more than 0 and less than 1.

According to another aspect of the present invention, a laminated film is provided. The laminated film has at least the above-mentioned birefringent film and a base material.

According to another aspect of the present invention, a method of producing a birefringent is provided. The method includes the following steps of (1) to (3):

(1) a step of preparing a solution including at least one polycyclic compound containing a —SO₃M group and/or a —COOM group, in which M represents a counter ion, and a solvent, and showing a nematic liquid crystal phase;

(2) a step of preparing a base material, at least one surface of which has been subjected to a hydrophilization treatment;

(3) a step of applying the solution prepared in the step (1) above onto the surface of the base material prepared in the step (2) above, the surface being subjected to hydrophilization treatment, and drying the base material.

In a preferred embodiment, the hydrophilization treatment is a corona treatment, a plasma treatment, an alkali treatment, or an anchor coat treatment.

In a preferred embodiment, the base material is a glass substrate or a polymer film.

According to another aspect of the present invention, a polarizing plate is provided. The polarizing plate has at least the birefringent film and a polarizer.

### EFFECTS OF THE INVENTION

In the birefringent film of the present invention, the refractive index ellipsoid satisfies the relationship represented by nx>nz>ny and shows a high in-plane birefringent index. Thus, as compared with a conventional birefringent film, the thickness is sharply reduced, and a desired retardation value can be obtained. Moreover, a method of producing a birefringent film of the present invention involves applying a solution onto a base material and drying the resultant, and thus, is excellent in productivity, and can provide a thin birefringent film which satisfies the relationship represented by nx>nz>ny.

### BEST MODE FOR CARRYING OUT THE INVENTION

### [A. Outline of Birefringent Film of the Present Invention]

In a birefringent film of the present invention, the refractive index ellipsoid satisfies the relationship represented by nx>nz>ny. Moreover, the birefringent film of the present invention is formed of at least one polycyclic compound including a —SO₃M group and/or a —COOM group. Specifically, the birefringent film of the present invention includes at least one polycyclic compound containing a —SO₃M group and/or a —COOM group. Here, M represents a counter ion. The above-mentioned —SO₃M group represents a sulfonic acid group or a sulfonate group and the above-mentioned —COOM group represents a carboxylic acid group or a carboxylate group.

The “birefringent film” as used in the specification refers to a film that shows birefringence in the in-plane direction and/or in the thickness direction, and encompasses a film whose birefringent index at a wavelength of 590 nm in the in-plane direction and/or in the thickness direction is 1×10⁻⁴ or higher. The “nx>nz>ny” refers to an optical anisotropy of a birefringent film when a refractive index in a direction in which the refractive index becomes maximum in a plane of a birefringent film (i.e., slow axis direction) is defined as nx; a refractive index in a direction perpendicular to the slow axis direction in a plane (i.e., fast axis direction) is defined as ny; and a refractive index in the thickness direction is defined as nz.

The above-mentioned polycyclic compound is an organic compound having two or more, preferably 3 to 8, and more preferably 4 to 6, of aromatic rings and/or heterocyclic rings in the molecular structure. In the case of the above-mentioned polycyclic compounds, a transparent birefringent film, which has low or no absorption in a visible light area can be obtained.

In such a birefringent film, the refractive index ellipsoid satisfies the relationship represented by nx>nz>ny and shows a high in-plane birefringent index. Thus, as compared with a conventional birefringent film, the thickness is sharply reduced, and a desired retardation value can be obtained. The inventors of the present invention assume that the birefringent film of the present invention shows a high birefringent property based on that, since the polycyclic compound containing a —SO₃M group and/or a —COOM group is likely to form an aggregation in a solution, and has a high ordering property of a state where the aggregation is formed, a film formed of such a solution also shows a high alignment property. In the present invention, among actions of the —SO₃M group and/or the —COOM group, which are/is contained in a polycyclic compound, exerted on the birefringent film, one action is to improve the solubility of the polycyclic compound in a solvent to thereby enable film formation by a solvent casting method; and another action is to three-dimensionally control the refractive index to thereby obtain a refractive index ellipsoid satisfying the relationship represented by nx>nz>ny.

The in-plane birefringent index (Δn[590]=nx−ny) of the birefringent film of the present invention at a wavelength of 590 nm is preferably 0.05 or higher, more preferably 0.1 to 0.5, and particularly preferably 0.2 to 0.4. In should be noted that the above-mentioned Δn[590] can be suitably adjusted to within the above-mentioned range depending on the molecular structure of a polycyclic compound. Conventionally, a birefringent film in which the refractive index ellipsoid satisfies the relationship represented by nx>nz>ny, and the Δn[590] is 0.05 or more has not been obtained. According to the present invention, by the use of the polycyclic compound containing a —SO₃M group and/or a —COOM group, a birefringent film which satisfies such properties can be first obtained.

The thickness of the above-mentioned birefringent film is preferably 0.05 μm to 10 μm, more preferably 0.1 μm to 8 μm, and particularly preferably 0.1 μm to 6 μm. By adjusting the thickness of the above-mentioned birefringent film to within the above mentioned range, when the birefringent film is, for example, used for a liquid crystal display, a range of retardation values useful for improvement of display properties can be obtained.

### [B. Polycyclic Compound]

Any suitable polycyclic compounds can be used as the polycyclic compound used in the present invention insofar as the polycyclic compounds have a —SO₃M group and/or a —COOM group. It is preferred that the above-mentioned polycyclic compound show a liquid crystal phase in a solution state (i.e., lyotropic liquid crystal).

The above-mentioned liquid crystal phase is preferably a nematic liquid crystal phase in terms of excellent alignment.

The above-mentioned birefringent film preferably contains, as a polycyclic compound, an acenaphtho[1,2-b]quinoxaline derivative represented by General Formula (I). In General Formula (I), i, j, k, and l each independently represent an integer of 0 to 4; m and n each independently represent an integer of 0 to 6; R₁ and R₂ each represent a C₁₋₆ alkyl group; and M's may be the same or different, and each M represent a counter ion. It should be noted that i, j, k, l, m, and n are not simultaneously 0. The above-mentioned birefringent film is a polycyclic compound represented by General Formula (I), and may be formed of a composition containing two or more of substances in which substitution positions of a —SO₃M group and/or a —COOM group are different from each other.

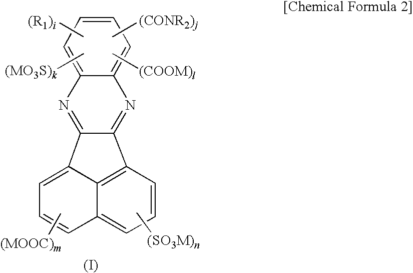

Such a polycyclic compound can form a stable liquid crystal phase in a solution, and can produce a transparent birefringent film which has a high in-plane birefringent index and has low or no absorption in a visible light area from a solution by a solvent casting method.

In General Formula (I), M represents a counter ion, and is preferably a hydrogen ion (hydrogen atom), an alkali metal ion (alkali metal atom) such as Na⁺ and K⁺, an alkaline earth metal ion (alkaline earth metal atom), another metal ion (another metal atom), or a substituted or non-substituted ammonium ion. Mentioned as the above-mentioned another metal ion are, for example, Ni²⁺, Fe³⁺, Cu²⁺, Ag⁺, Zn²⁺, Al³⁺, Pd²⁺, Cd²⁺, Sn²⁺, Co²⁺, Mn²⁺, Ce³⁺, etc. For example, when the birefringent film of the present invention is formed of an aqueous solution, a group which improves the solubility in water is selected as the above-mentioned M at the beginning, and after film formation, the above-mentioned M can be replaced by a group which is insoluble in water or is difficult to dissolve in water so as to improve the water resistance of a film.

The above-mentioned acenaphtho[1,2-b]quinoxaline derivative can be obtained by sulfonating an acenaphtho[1,2-b]quinoxaline carboxylic acid derivative with sulfuric acid, fuming sulfuric acid, or chlorosulfonic acid as shown below.

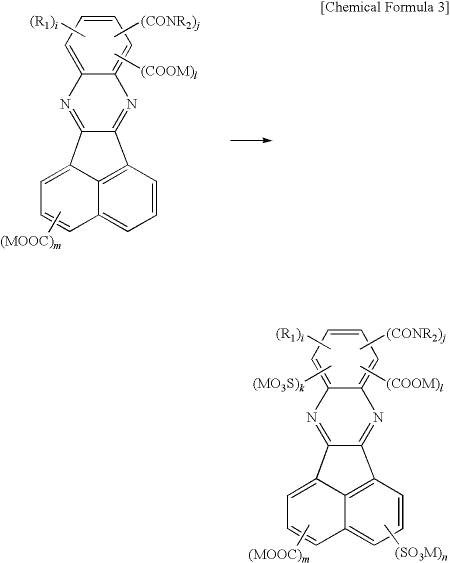

In Chemical Formula (3), i, j, k, and l each independently represent an integer of 0 to 4; m and n each independently represent an integer of 0 to 6; R₁ and R₂ each represent a C₁₋₆ alkyl group; and M's may be the same or different, and each M represents a counter ion. It should be noted that i, j, k, l, m, and n are not simultaneously 0.

Or, the acenaphtho[1,2-b]quinoxaline derivative can also be obtained by subjecting a sulfo and/or carboxy derivative of benzene-1,2-diamine and a sulfo and/or carboxy derivative of acenaphthoquinone to a condensation reaction as shown below.

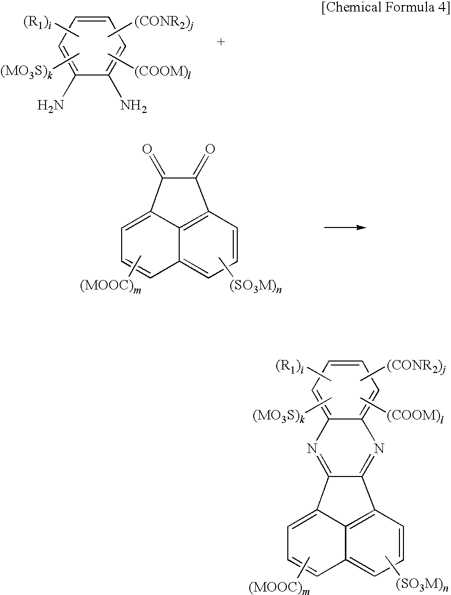

where i, j, k, and l each independently represent an integer of to 4; m and n each independently represent an integer of 0 to 6; R₁ and R₂ each represent a C₁₋₆ alkyl group; and M's may be the same or different, and each M represents a counter ion. It should be noted that i, j, k, l, m, and n are not simultaneously 0.

### [C. Various Physical Properties of Birefringent Film]

The transmittance of the above-mentioned birefringent film at a wavelength of 590 nm is preferably 85% or more, and more preferably 90% or more.

The in-plane retardation value (Re[590]) of the above-mentioned birefringent film at a wavelength of 590 nm may be adjusted to a suitable value according to the purpose. The above-mentioned Re[590] is 10 nm or more, preferably 20 nm to 1,000 nm, more preferably 50 nm to 500 nm, and particularly preferably nm to 400 nm. In the specification, the in-plane retardation value (Re[λ]) refers to an in-plane retardation value at a wavelength of % (nm) at 23° C. The Re[λ] can be calculated by the following equation; Re[λ]=(nx−ny)×d, when the film thickness is defined as d (nm).

The Rth[590] of the above-mentioned birefringent film can be adjusted to a suitable value in a range where the refractive index ellipsoid satisfies the relationship represented by nx>nz>ny. A difference between the in-plane retardation value (Re[590]) and the thickness direction retardation value (Rth[590]) of the above-mentioned birefringent film at a wavelength of 590 nm is preferably 10 nm to 800 nm, more preferably 10 nm to 400 nm, and particularly preferably 10 nm to 200 nm. In the specification, the thickness direction retardation value (Rth[k]) refers to a thickness direction retardation value at a wavelength of λ (nm) at 23° C. The Rth[λ] can be calculated by the following equation; Rth[λ]=(nx−nz)×d, when the film thickness is defined as d (nm).

The Nz coefficient of the above-mentioned birefringent film is preferably more than 0 and less than 1, more preferably 0.1 to 0.8, particularly preferably 0.1 to 0.7, and most preferably 0.1 to 0.6. When the Nz coefficient falls under the above-mentioned range, the birefringent film of the present invention can be used for optical compensation of a liquid crystal cell of various driving modes. In the specification, the Nz coefficient refers to a value calculated from Rth[590]/Re[590].

The wavelength dispersion value (D) of the above-mentioned birefringent film is preferably 1.05 or more, more preferably 1.06 to 1.15, and most preferably 1.07 to 1.12. In the specification, the wavelength dispersion value (D) is a value calculated from the following equation; D=Re[480]/Re[550]. Conventionally, among birefringent films produced by stretching a polymer film, a film showing such a sharp wavelength dependence has not been obtained. In the birefringent film of the present invention, a retardation value measured with a short-wavelength light is sufficiently larger than a retardation value measured with a long-wavelength light. Thus, the demonstration of a sharp wavelength dependence of retardation is one of the features of the birefringent film of the present invention.

### [D. Method of Producing Birefringent Film]

In one Embodiment, the birefringent film of the present invention is produced by a method including the following steps of (1) to (3):

(1) a step of preparing a solution including at least one polycyclic compound containing a —SO₃M group and/or a —COOM group (M represents a counter ion), and a solvent, and showing a nematic liquid crystal phase;

(2) a step of preparing a base material, at least one surface of which has been subjected to a hydrophilization treatment; and

(3) a step of applying the solution prepared in the step (1) above onto the surface of the base material prepared in the step (2) above, the surface being subjected to hydrophilization treatment, and drying the resultant.

According to such a method, a laminated film having at least the birefringent film and the base material can be obtained.

As the polycyclic compound containing a —SO₃M group and/or a —COOM group (M represents a counter ion) used in the step (1) above, an appropriate compound can be suitably selected from the above-mentioned compounds. In the step (1) above, the above-mentioned solution is prepared by dissolving, in a solvent, two or more polycyclic compounds in which substitution positions of a —SO₃M group and/or a —COOM group are different from each other. The kinds of polycyclic compound contained in the above-mentioned solution are preferably 2 or more kinds, more preferably 2 to 6 kinds, and particularly preferably 2 to 4 kinds, excluding compound contained in a minute amount as an impurity.

The above-mentioned solvent is used for dissolving the above-mentioned polycyclic compound to develop a nematic liquid crystal phase. Any suitable solvent can be selected as the above-mentioned solvent. For example, as the above-mentioned solvent, inorganic solvents such as water may be used, and organic solvents such as alcohols ketones, ethers, esters, aliphatic and aromatic hydrocarbons, halogenated hydrocarbons, amides, and cellosolves may be used. Examples of the solvent include n-butanol, 2-butanol, cyclohexanol, isopropyl alcohol, t-butyl alcohol, glycerin, ethylene glycol, acetone, methyl ethyl ketone, methyl isobutyl ketone, cyclohexanone, cyclopentanone, 2-pentanone, 2-hexanone, diethyl ether, tetrahydrofuran, dioxane, anisole, ethyl acetate, butyl acetate, methyl lactate, n-hexane, benzene, toluene, xylene, chloroform, dichloromethane, dichloroethane, dimethyl formamide, dimethyl acetamide, methyl cellosolve, and ethyl cellosolve. The above-mentioned solvents can be used alone or in combination.

Water is most preferred as the above-mentioned solvent. The electric conductivity of water is preferably 20 μS/cm or lower, more preferably 0.001 μS/cm to 10 μS/cm, and particularly preferably 0.01 μS/cm to 5 μS/cm. The lower limit of the electric conductivity of water is 0 μS/cm. By adjusting the electric conductivity of water to within the above-mentioned range, a birefringent film having a high in-plane birefringent index can be obtained.

The concentration of a polycyclic compound in the above-mentioned solution can be suitably adjusted to within a range, in which a nematic liquid crystal phase is developed, according to the type of a polycyclic compound to be used. The concentration of a polycyclic compound in the above-mentioned solution is preferably 5% by weight to 40% by weight, more preferably 5% by weight to 35% by weight, and particularly preferably 5% by weight to 30% by weight. By adjusting the concentration of the solution to within the above-mentioned range, the solution can form a stable liquid crystal state. The above-mentioned nematic liquid crystal phase can be identified and distinguished from any other phase on the basis of an optical pattern of a liquid crystal phase observed with a polarization microscope.

The above-mentioned solution may further contain any suitable additive. Mentioned as the above-mentioned additive are, for example, a surfactant, plasticizer, thermostabilizer, light stabilizer, lubricant, anti-oxidant agent, UV absorber, flame retardant, colorant, antistatic agent, compatibilizer, cross linking agent, thickener, etc. The addition amount of the above-mentioned additive is preferably larger than 0 part by weight and 10 parts by weight or smaller based on 100 parts by weight of solution.

The above-mentioned solution may further contain a surfactant. A surfactant is used for improving the wettability and application properties of a polycyclic compound to the surface of a base material. The above-mentioned surfactant is preferably a nonionic surfactant. The addition amount of the above-mentioned surfactant is preferably larger than 0 part by weight and 5 parts by weight or smaller based on 100 parts by weight of solution.

The “hydrophilization treatment” in the step (2) above refers to treatment for reducing the contact angle of water to the base material. The above-mentioned hydrophilization treatment is used for improving the wettability and application properties of the surface of a base material to which a polycyclic compound is applied. The above-mentioned hydrophilization treatment reduces the contact angle of water to the base material at 23° C. by preferably 10% or more, more preferably 15% to 80%, and particularly preferably 20% to 70% as compared with the contact angle before the hydrophilization treatment. It should be noted that the reduction percentage (%) is calculated by the following equation; {(Contact angle before treatment−Contact angle after treatment)/Contact angle before treatment}×100.

Further, the above-mentioned hydrophilization treatment reduces the contact angle of water to the base material at 23° C. by preferably 5′ or more, more preferably 100 to 650, and particularly preferably 200 to 65° as compared with the contact angle of water to the base material at 23° C. before treatment.

Further, the above-mentioned hydrophilization treatment adjusts the contact angle of water to the base material at 23° C. to preferably 5° to 60°, more preferably 5° to 50°, and particularly preferably 5° to 45°. By adjusting the contact angle of water to the base material to within the above-mentioned range, a birefringent film which shows a high in-plane birefringent index and has small thickness variations can be obtained.

Any suitable methods can be employed as the above-mentioned hydrophilization treatment. The above-mentioned hydrophilization treatment may be, for example, dry treatment or wet treatment. Mentioned as the dry treatment are, for example, electro-discharge treatment such as corona treatment, plasma treatment, and glow discharge treatment; flame treatment; ozone treatment; UV ozone treatment; electrolytic-dissociation actinic-rays treatment such as, ultraviolet treatment and electron beam treatment. Mentioned as the wet treatment are, for example, supersonic treatment using a solvent such as water and acetone, alkali treatment, and anchor coat treatment. These treatments may be used alone or in combination. Preferred as the above-mentioned hydrophilization treatment is corona treatment, plasma treatment, alkali treatment, or anchor coat treatment. By the above-mentioned hydrophilization treatment, a birefringent film having high alignment properties and small thickness variations can be obtained. The conditions of the above-mentioned hydrophilization treatment such as treatment time and strength can be suitably and appropriately adjusted in such a manner that the contact angle of water to the base material falls under the above-mentioned range.

The above-mentioned corona treatment refers to treatment for reforming the base material surface by causing the base material to pass through corona discharge which is generated by ionization of air between electrodes due to dielectric breakdown by applying high frequency current and high voltage to between electrodes insulated and a grounded dielectric roll. Typically mentioned as the above-mentioned plasma treatment is treatment for reforming the base material surface by causing the base material to pass through low-temperature plasma which is generated by ionization of some of gas molecules at the time when glow discharge is induced in inorganic gases such as a low-pressure inert gas, oxygen, and a halogen gas. Typically as the above-mentioned ultrasonic cleaning treatment is treatment for improving the wettability of the base material by removing contaminants on the base material surface by immersing the base material in water or an organic solvent, and applying ultrasonic wave to the base material. Typically as the above-mentioned alkali treatment is treatment for reforming the base material surface by immersing the base material in an alkali treatment liquid in which a basic substance is dissolved in water or an organic solvent. Typically as the above-mentioned anchor coat treatment is treatment for applying an anchor coat agent to the base material surface.

The base material used in the present invention is used for uniformly casting a solution containing the above-mentioned polycyclic compound and solvent. Any suitable base material can be selected as the above-mentioned base material. Mentioned as the above-mentioned base material are, for example, a glass substrate, a quartz substrate, a polymer film, a plastic substrate, metal plates such as an aluminum plate and an iron plate, a ceramic substrate, a silicon wafer, etc. Preferred as the above-mentioned base material is a glass substrate or a polymer film.

Any suitable substances may be selected as the above-mentioned glass substrate. Preferably, the above-mentioned glass substrate is a substrate to be used for a liquid crystal cell, and is, for example, a soda-lime (blue plate) glass containing an alkali component or a low alkali borax glass. A commercially available substance can be used for the above-mentioned glass substrate as it is. Mentioned as a commercially available glass substrate are, for example, a glass code: 1737 manufactured by CORNING Corporation, a glass code: AN635 manufactured by Asahi glass Co., Ltd., or a glass code: NA-35 manufactured by NH TECHNO GLASS Corporation, etc.

Any suitable substances can be selected as a resin for forming the above-mentioned polymer film. Preferably, the above-mentioned polymer film includes a thermoplastic resin. Examples of the thermoplastic resin include a polyolefin resin, a cycloolefin-based resin, a polyvinyl chloride-based resin, a cellulose-based resin, a styrene-based resin, polymethyl methacrylate, polyvinyl acetate, a polyvinylidene chloride-based resin, a polyamide-based resin, a polyacetal-based resin, a polycarbonate-based resin, a polybutylene terephthalate-based resin, a polyethylene terephthalate-based resin, a polysulfone-based resin, a polyethersulfone-based resin, a polyetherether ketone-based resin, a polyarylate-based resin, a polyamide imide-based resin, a polyimide-based resin. The above-mentioned thermoplastic resins can be used alone or in combination. Moreover, the above-mentioned thermoplastic resins can also be used after being subjected to any suitable polymer modification. Mentioned as the above-mentioned polymer modification are, for example, modifications of copolymerization, cross-linking formation, molecular terminal, stereoregularity, etc.

The base material used for the present invention is preferably a polymer film containing a cellulose-based resin. This is because a birefringent film having the following features can be obtained: the wettability of a polycyclic compound is excellent; the in-plane birefringent index is high; and thickness variations are small.

As the cellulose-based resin, any appropriate resin can be adopted. The cellulose-based resin is preferably a cellulose organic acid ester or a cellulose-mixed organic acid ester in which a part or an entirety of a hydroxyl group of cellulose is replaced by an acetyl group, a propionyl group and/or a butyl group. Specific examples of the cellulose organic acid ester include cellulose acetate, cellulose propionate, and cellulose butyrate. Specific examples of the cellulose-mixed organic acid ester include cellulose acetate propionate and cellulose acetate butyrate. The cellulose-based resin can be produced, for example, by a method described in paragraphs [0040] and [0041] of JP 2001-188128 A.

As the base material used in the present invention, a commercially available polymer film can be used as it is. Alternatively, a commercially available film subjected to secondary treatment such as stretching treatment and/or shrinking treatment can be used. Examples of the commercially available polymer film containing a cellulose-based resin include FUJITAC series (ZRF80S, TD80UF, TDY-80UL (trade name)) manufactured by Fuji Photo Film Co., Ltd. and “KC8UX2M” (trade name) manufactured by Konica Minolta Opto, Inc.

The thickness of the above-mentioned base material is preferably 20 μm to 100 μm. By adjusting the thickness of the base material to within the above-mentioned range, the handling properties and application properties of the base material become excellent.

The application rate of a solution in the step (3) above is preferably 50 mm/second or more, and more preferably 100 mm/second or more. By adjusting the application rate to within the above-mentioned range, shearing force suitable for alignment of a polycyclic compound is applied to the solution used in the present invention, and a birefringent film having a high in-plane birefringent index and small thickness variations can be obtained.

As a method of applying the above-mentioned solution onto the surface of the base material, application methods using an appropriate coater may be suitably adopted. Examples of the above-mentioned coater include a reverse roll coater, a positive rotation roll coater, a gravure coater, a knife coater, a rod coater, a slot die coater, a slot orifice coater, a curtain coater, a fountain coater, an air doctor coater, a kiss coater, a dip coater, a bead coater, a blade coater, a cast coater, a spray coater, a spin coater, an extrusion coater, and a hot melt coater. Preferable examples include a reverse roll coater, a positive rotation roll coater, a gravure coater, a rod coater, a slot die coater, a slot orifice coater, a curtain coater, and a fountain coater. By application methods using the above-mentioned coaters, a birefringent film having small thickness variations can be obtained.

As a method of drying the above-mentioned solution, appropriate methods may be suitably adopted. Examples of the methods of drying the solution include a drying means such as an air circulation type temperature-controlled oven in which hot air or cold air circulates, a heater using a micro-wave or an infrared ray, a roll heated for regulating temperature, a heat pipe roll, or a metal belt.

It is preferred that a temperature for drying the above-mentioned solution be the isotropic phase transition temperature of the above-mentioned solution or lower, and that the solution be dried by gradually increasing a temperature from a low temperature to a high temperature. The above-mentioned drying temperature is preferably 10° C. to 80° C., and more preferably 20° C. to 60° C. When the drying temperature is within the above-mentioned temperature range, a birefringent film having small thickness variations can be obtained.

A time for drying the above-mentioned solution can be suitably selected according to a drying temperature or a type of solvent. In order to obtain a birefringent film having small thickness variations, the drying time is, for example, 1 to 30 minutes and preferably 1 to 10 minutes.

The method of producing the birefringent film of the present invention preferably further includes a step (4) after steps of (1) to (3) described above:

(4) a step of bringing a solution containing at least one compound salt selected from the group consisting of an aluminum salt, barium salt, lead salt, chromium salt, strontium salt, and compound salt having two or more amino groups in the molecule into contact with the film obtained in the step (3) above.

In the present invention, the step (4) above is used for making the birefringent film to be obtained insoluble or slightly-soluble in water. Mentioned as the above-mentioned compound salt are, for example, aluminum chloride, barium chloride, lead chloride, chromium chloride, strontium chloride, 4,4′-tetramethyl diamino diphenylmethane hydrochloride, 2,2′-dipyridyl hydrochloride, 4,4′-dipyridyl hydrochloride, melamine hydrochloride, tetraminopyrimidine hydrochloride, etc. With such a compound salt, a birefringent film excellent in water resistance properties can be obtained.

The concentration of the above-mentioned compound salt in the solution containing the compound salt is preferably 3% by weight to 40% by weight, and particularly preferably 5% by weight to 30% by weight. A birefringent film excellent in durability can be obtained by bringing a birefringent film into contact with a solution containing a compound salt having a concentration in the above-mentioned range.

As a method of bringing the birefringent film obtained in the step (3) above into contact with a solution containing the above-mentioned compound salt, any suitable method, such as a method of applying a solution containing the above-mentioned compound salt onto the surface of the birefringent film and a method of immersing the birefringent film in a solution containing the above-mentioned compound salt, may be employed. When these methods are employed, it is preferred that the obtained birefringent film be washed with water or a suitable solvent. Further, by drying the film, a laminate excellent in adhesiveness of the interface between the base material and the birefringent film can be obtained.

### [E. Intended Use of Birefringent Film]

There is no limitation on the intended use of the birefringent film of the present invention. Typically, a λ/4 plate, λ/2 plate, viewing-angle widening film, and antireflection film for flat-panel displays of a liquid crystal display are mentioned. In one Embodiment, the above-mentioned birefringent film may be laminated with a polarizer to be used as a polarizing plate. Hereinafter, the polarizing plate will be described.

### [F. Polarizing Plate of the Present Invention]

The polarizing plate of the present invention has at least the above-mentioned birefringent film and a polarizer. The above-mentioned polarizing plate may include a laminated film having at least a base material and a birefringent film, or may include another birefringent film and any suitable protective layer. Practically, between each layer of a component member of the above-mentioned polarizing plate, any appropriate adhesion layer is provided, and thus, a polarizer and each component member are attached to each other.

As the above-mentioned polarizer, any suitable substances can be employed insofar as the substances convert natural light or polarized light into linearly polarized light. The above-mentioned polarizer is preferably a stretched film containing, as a main component, a polyvinyl alcohol resin containing iodine or dichromatic dye. The thickness of the above-mentioned polarizer is usually 5 μm to 50 μm.

Any suitable substances can be selected as the above-mentioned adhesion layer insofar as the substances join surfaces of adjacent members, and integrate the members with a practically sufficient adhesive strength in a practically sufficient adhesion time. As a material forming the above-mentioned adhesion layer, adhesives, pressure-sensitive adhesives, and anchor coat agents are mentioned, for example. The above-mentioned adhesion layer may have a multilayer structure in which an anchor coat agent layer is formed on the surface of an adherend, and an adhesive layer or pressure-sensitive adhesive layer is formed thereon, or may be a thin layer (also referred to as a hairline) which cannot be recognized macroscopically. An adhesion layer disposed at one side of a polarizer and an adhesion layer disposed at the other side thereof may be the same or different with each other.

The angle of attaching the polarizer to the birefringent film in the above-mentioned polarizing plate can be suitably determined according to the object of the polarizing plate. When the above-mentioned polarizing plate is used, for example, as an antireflection film, the angle formed by the direction of an absorption axis of the above-mentioned polarizer and the direction of a slow axis of the above-mentioned birefringent film is preferably 25° to 65° and more preferably 35° to 55°. When the above-mentioned polarizing plate is used as a viewing angle widening film, the angle formed by the direction of an absorption axis of the above-mentioned polarizer and the direction of a slow axis of the above-mentioned birefringent film is substantially parallel or substantially perpendicular to each other. The “substantially parallel” as used in the specification refers to that the angle formed by the direction of an absorption axis of a polarizer and the direction of a slow axis of a birefringent film encompasses a range of 0°±10°, and is preferably 0°±5°. The “substantially perpendicular” as used in the specification refers to that the angle formed by the direction of an absorption axis of a polarizer and the direction of a slow axis of a birefringent film encompasses a range of 90±10°, and is preferably 90°±5°.

### EXAMPLES

Hereinafter, the present invention will be further described with reference to the following examples. It should be noted that the present invention is not limited only to the following examples. Each analysis method used in each example is as follows.

### (1) Method of Measuring Thickness:

When the thickness was lower than 10 um, the thickness was measured using a spectrophotometer for thin films [Otsuka Electronics Co., Ltd., product name “Instant multi-photometry system MCPD-2000”)].

### (2) Method of Measuring Transmittance (T[590]), In-Plane Birefringent Index (Δn[590]), Retardation Value (Re[λ], Rth[λ]):

Transmittance (T[590]), in-plane birefringent index (Δn[590]), retardation value (Re[λ], Rth[λ]) were measured at 23° C. using “KOBRA21-ADH” (trade name) manufacture by Oji Scientific Instruments. Note that an average refractive index was determined by using measured values obtained with the use of an Abbe refractometer (Atago Co., Ltd., product name “DR-M4”).

### (3) Method of Measuring Electrical Conductivity:

With an aqueous solution whose concentration was adjusted to 0.05% by weight, an electrode of a solution electric conductivity meter [manufactured by KYOTO ELECTRONICS MANUFACTURING CO., LTD., product name “CM-117”] was washed. Then, a 1 cm³ container connected to the electrode was filled with a sample. Then, a point where a displayed electrical conductivity becomes constant was defined as a measurement value.

### (4) Method of Measuring Contact Angle of Water:

A liquid was added dropwise to a base material, and the contact angle after 5 seconds was measured using a solid-liquid phase interface analyzer [manufactured by Kyowa Interface Science Co., Ltd., product name “Drop Master300”]. As the measurement, static contact angle measurement was carried out. Ultrapure water was used as water and a droplet was 0.5 μl. The measurement was repeated ten times for each base material, and the average value of the obtained measurement values was defined as a measurement value.

### Synthesis Example 1

### Synthesis of acenaphtho[1,2-b]quinoxaline-9-carboxylic acid

500 ml of dimethylformamide was added to a mixture of 10 g of purified acenaphthene quinoline and 8.4 g of purified 3,4-diaminobenzoic acid. The reactant was continued to stir at room temperature for 21 hours. The precipitate was filtered to thereby obtain a crude product. The crude product was dissolved in a heated dimethylformamide, and filtered again. Then, the resultant was washed with dimethylformamide and water for purification.

### Synthesis Example 2

### Synthesis of mixture of ammonium 2-sulfo-acenaphtho[1,2-b]quinoxaline-9-carboxylate and ammonium 5-sulfo-acenaphtho[1,2-b]quinoxaline-9-carboxylate

As shown in the reaction path described later, 3 g of acenaphtho[1,2-b]quinoxaline-9-carboxylic acid obtained in Synthesis Example 1 was added to 30% fuming sulfuric acid (15 ml). The reactant was stirred at 70° C. for 17.5 hours. The obtained solution was diluted at a temperature of 40° C. to 50° C. with 33 ml of water, and further stirred for 12 hours. The precipitate was filtered to thereby obtain a mixture containing 5-sulfo-acenaphtho[1,2-b]quinoxaline-9-carboxylic acid and 2-sulfo-acenaphtho[1,2-b]quinoxaline-9-carboxylic acid.

The mixture was dissolved in 2 L of pure water (electrical conductivity: 1.7 μS/cm), and further ammonium hydroxide was added thereto to neutralize acid. The obtained aqueous solution was put in a supply tank, and purified using a triple flat membrane evaluation device equipped with a reverse osmosis membrane (manufactured by NITTO DENKO CORP., trade name “NTR-7430”) until the electrical conductivity of waste liquid of the device reaches 14.3 μS/cm (in terms of 1% by weight). Next, the purified aqueous solution was adjusted using a rotary evaporator in such a manner that the concentration of the polycyclic compound in the aqueous solution became 21.1% by weight. When the aqueous solution obtained here was observed under a polarizing microscope, a nematic liquid crystal phase was developed at 23° C. By liquid chromatographic analysis, the mixing ratio of ammonium 2-sulfo-acenaphtho[1,2-b]-quinoxaline-9-carboxylate, and ammonium 5-sulfo-acenaphtho[1,2-b]quinoxaline-9-carboxylate was determined, which showed that the composition ratio was 46:54.

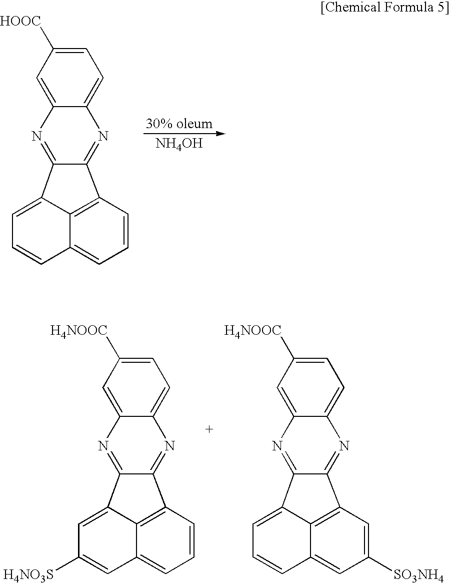

### Synthesis Example 3

### Synthesis of mixture of ammonium

### 2-sulfo-acenaphtho[1,2-b]quinoxaline-9-carboxylate, ammonium 3-sulfo-acenaphtho[1,2-b]quinoxaline-9-carboxylate, ammonium 4-sulfo-acenaphtho[1,2-b]quinoxaline-9-carboxylate, and ammonium 5-sulfo-acenaphtho[1,2-b]quinoxaline-9-carboxylate

As shown in the reaction path described later, 50 g of acenaphthenequinone was added to 20% fuming sulfuric acid (150 ml), and stirred at 25° C. for 12 hours. The obtained solution was diluted at 40° C. with 140 ml of water, and further stirred for 12 hours. The precipitate was filtered and a cake collected on a filter paper was suspended in 300 ml of acetic acid. The precipitate was filtered again, and then dissolved in 200 ml of acetone. The obtained solution was diluted with 700 ml of dichloromethane. The precipitate was filtered again, and air-dried without heating to thereby obtain 1,2-dioxoacenaphthylene-4-sulfonic acid and 1,2-dioxoacenaphthylene-5-sulfonic acid.

A suspension containing 1.5 g of 3,4-diaminobenzoic acid was added to 30 ml of acetic acid and a suspension (2.6 g) containing 1,2-dioxoacenaphthylene-4-sulfonic acid and 1,2-dioxoacenaphthylene-5-sulfonic acid was added to 100 ml of acetic acid. The obtained reactant was stirred for 12 hours. The precipitate was filtered. A cake on a filter paper was dissolved in 300 ml of water. The solution was filtered through a glass fiber filter, and diluted with 300 ml of concentrated hydrochloric acid. The precipitate was filtered to thereby obtain a mixture of 2-sulfo-acenaphtho[1,2-b]quinoxaline-9-carboxylic acid, 3-sulfo-acenaphtho[1,2-b]quinoxaline-9-carboxylic acid, 4-sulfo-acenaphtho[1,2-b]quinoxaline-9-carboxylic acid, and 5-sulfo-acenaphtho[1,2-b]quinoxaline-9-carboxylic acid.

The mixture was dissolved in 1 L of pure water (electrical conductivity: 1.7 μS/cm), and further ammonium hydroxide was added thereto to neutralize acid. The obtained aqueous solution was put in a supply tank, and purified using a triple flat membrane evaluation device equipped with a reverse osmosis membrane (manufactured by NITTO DENKO CORP., trade name “NTR-7430”) until the electrical conductivity of waste liquid of the device reaches 252 μS/cm (in terms of 1% by weight). Next, the purified aqueous solution was adjusted using a rotary evaporator in such a manner that the concentration of the polycyclic compound in the aqueous solution became 23.5% by weight. When the aqueous solution obtained here was observed under a polarizing microscope, a nematic liquid crystal phase was developed at 23° C. By liquid chromatographic analysis, the mixing ratio of ammonium 2-sulfo-acenaphtho[1,2-b]-quinoxaline-9-carboxylate, ammonium 3-sulfo-acenaphtho[1,2-b]quinoxaline-9-carboxylate, ammonium 4-sulfo-acenaphtho[1,2-b]quinoxaline-9-carboxylate, and ammonium 5-sulfo-acenaphtho[1,2-b]quinoxaline-9-carboxylate was determined, which showed that the composition ratio was 23:25:25:27.

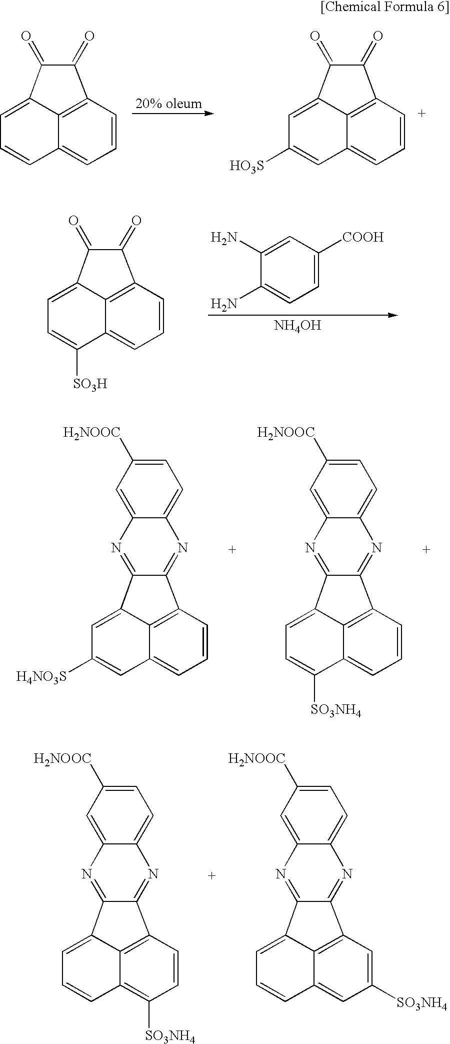

### Synthesis Example 4

### Synthesis of 9-methyl-acenaphtho[1,2-b]quinoxaline

To a reactor equipped with a stirrer, 1 L of glacial acetic acid and 18.2 g of purified acenaphthenequinone were loaded. The mixture was stirred for 15 minutes under nitrogen bubbling, and then 12.2 g of 3,4-diaminotoluene was added. Then, stirring was continued under nitrogen bubbling for 3 hours for reaction. Ion exchange water was added to the obtained reaction mixture, and then the precipitate was filtered to thereby obtain a crude product. The obtained crude product was re-crystallized using hot glacial acetic acid to obtain purified 9-methyl-acenaphtho[1,2-b]quinoxaline.

### Synthesis Example 5

### Synthesis of 9-methyl-acenaphtho[1,2-b]quinoxaline-2,5-disulfonic acid

As shown in the reaction path described later, 25 g of 9-methyl-acenaphtho[1,2-b]quinoxaline obtained in Synthesis Example 4 was added to 30% fuming sulfuric acid (175 ml). The mixture was stirred at 120° C. for 20 hours for reaction. While keeping the obtained solution at 40° C. to 50° C., 350 ml of ion water was added thereto for dilution. Then, the resultant was further stirred for 3 hours. The precipitate was filtered, and then a cleaning operation in which the resultant was suspended in 300 g of acetone, followed by filtration was repeated 3 times. Then, the solid substance after filtration was dried under vacuum for 12 hours to thereby obtain 9-methyl acenaphtho[1,2-b]quinoxaline-2,5-disulfonic acid.

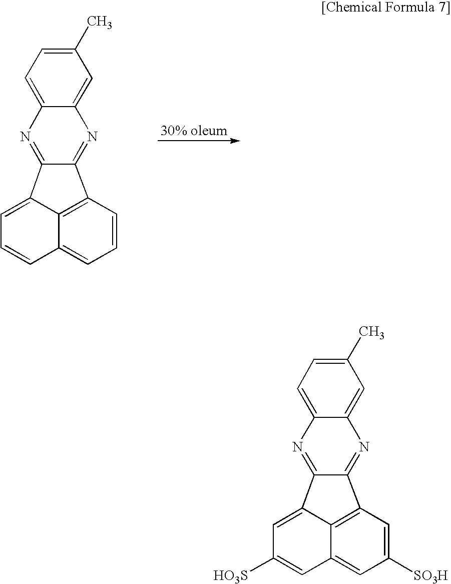

### Synthesis Example 6

### Synthesis of 4,5-diamino-2-methyl-benzenesulfonic acid

As shown in the reaction path described later, 30 g of 3,4-diaminotoluene was added to 4% fuming sulfuric acid (200 ml). The mixture was stirred at 140° C. for 4 hours for reaction. While keeping the obtained solution at 40° C. to 50° C., 400 ml of ion water was added thereto for dilution. Then, the resultant was further stirred for 3 hours. The precipitate was filtered, and then re-crystallized with water to thereby obtain 4,5-diamino-2-methyl-benzenesulfonic acid.

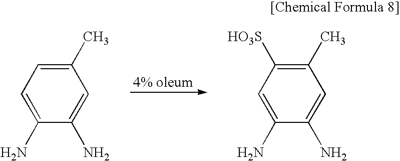

### Synthesis Example 7

### Synthesis of 10-methyl-acenaphtho[1,2-b]quinoxaline-9-sulfonic acid

To a reactor equipped with a stirrer, 1.5 L of glacial acetic acid and 18.2 g of purified acenaphthenequinone were loaded. The mixture was stirred for 15 minutes under nitrogen bubbling, and then 20.2 g of 4,5-diamino-2-methyl-benzensulfonic acid obtained in Synthesis Example 6 was added thereto. Then, stirring was continued under nitrogen bubbling for 3 hours for reaction. Ion exchange water was added to the obtained reaction mixture, and then the precipitate was filtered to thereby obtain a crude product. The obtained crude product was re-crystallized using glacial acetic acid to obtain purified 10-methyl-acenaphtho[1,2-b]quinoxaline-9-sulfonic acid.

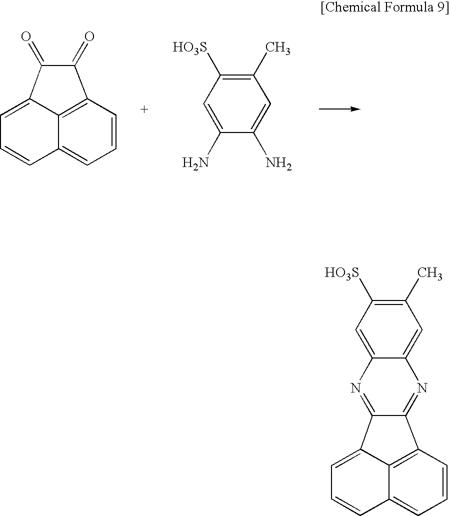

### Synthesis Example 8

### Synthesis of N-butyl-9-acenaphtho[1,2-b]quinoxalinecarboxamide

To a reactor equipped with a stirrer, 1.5 L of glacial acetic acid and 18.2 g of purified acenaphthenequinone were loaded. The mixture was stirred for 15 minutes under nitrogen bubbling, and then 20.7 g of N-butylbenzamide was added thereto. Then, stirring was continued under nitrogen bubbling for 3 hours for reaction. Ion exchange water was added to the obtained reaction mixture, and then the precipitate was filtered to thereby obtain a crude product. The obtained crude product was re-crystallized using glacial acetic acid to obtain purified N-butyl-9-acenaphtho[1,2-b]quinoxalinecarboxamide.

### Synthesis Example 9

### Synthesis of sulfonated product of N-butyl-9-acenaphtho[1,2-b]quinoxalinecarboxamide

As shown in the reaction path described later, 30 g of N-butyl-9-acenaphtho[1,2-b]quinoxalinecarboxamide obtained in Synthesis Example 8 was added to 30% fuming sulfuric acid (210 ml). The mixture was stirred at room temperature for 48 hours for reaction. While keeping the obtained solution at 40° C. to 50° C., 500 ml of ion water was added thereto for dilution. Then, the resultant was further stirred for 3 hours. The precipitate was filtered, and then a cleaning operation in which the resultant was suspended in 400 g of acetone, followed by filtration was repeated 3 times. Then, the solid substance after filtration was dried under vacuum at room temperature for 12 hours to thereby obtain sulfonated product of N-butyl-9-acenaphtho[1,2-b]quinoxalinecarboxamide.

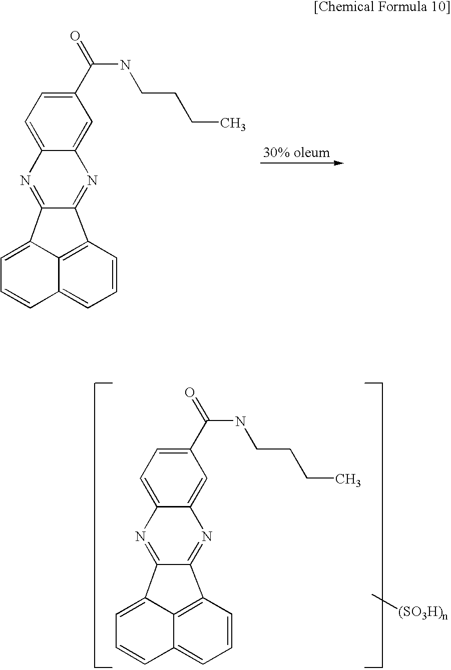

### Example 1

A polymer film [manufactured by Fuji Photo Film Co., Ltd., trade name “ZRF80S”] having a thickness of 80 μm and containing triacetyl cellulose as a main component was immersed in an aqueous solution in which sodium hydroxide was dissolved, and the surface thereof was subjected to alkali treatment (also referred to as saponification treatment). The contact angle of water to the above polymer film at 23° C. was 64.6° before the treatment and was 26.50 after the treatment. Next, the aqueous solution obtained in Synthesis Example 2 was applied to the alkali-treated surface of the polymer film using a bar coater [manufactured by BUSCHMAN Corporation, trade name “mayer rot HS1.5”]. Then, the resultant was dried by spraying air to the solution-applied surface thereof in a thermostat room having a temperature of 23° C. Thereafter, the resultant was further dried for 3 minutes in an air circulation dry oven having a temperature of 40° C. As a result, a birefringent film A in which the refractive index ellipsoid showed the relationship represented by nx>nz>ny was obtained on the surface of the polymer film containing triacetyl cellulose as a main component. The properties of the birefringent film A are illustrated in table 1.

### Example 2

Using the aqueous solution obtained in Synthesis Example 3, and the application and drying treatment were performed in the same manner as in Example 1 to thereby obtain a birefringent film B in which the refractive index ellipsoid showed the relationship represented by nx>nz>ny was obtained on the surface of the polymer film containing triacetyl cellulose as a main component. The properties of the birefringent film B are illustrated in table 1.

### Example 3

10 g of the 9-methyl-acenaphtho[1,2-b]quinoxaline-2,5-disulfonic acid obtained in Synthesis Example 5 above were dissolved in 500 ml of ion exchange water. The obtained aqueous solution was neutralized to pH=7 with 5% aqueous ammonium hydroxide solution. Then, the resultant was condensed to 29% using a rotary evaporator to prepare a coating agent. The coating agent was applied onto a 1.3 mm thick glass substrate using a bar coater [manufactured by BUSCHMAN Corporation, trade name “mayer rot HS1.5”], and naturally dried in a thermostat room having a temperature of 23° C. As a result, a birefringent film C in which the refractive index ellipsoid showed the relationship represented by nx>nz>ny was obtained on the glass substrate surface. The properties of the birefringent film C are illustrated in Table 1.

### Example 4

10 g of the 9-methyl-acenaphtho[1,2-b]quinoxaline-2,5-disulfonic acid obtained in Synthesis Example 5 above were dissolved in 500 ml of ion exchange water. The obtained aqueous solution was neutralized to pH=7 with a 5% aqueous sodium hydroxide solution. Then, the resultant was condensed to 25% using a rotary evaporator to prepare a coating agent. The coating agent was applied to a 1.3 mm thick glass substrate using a bar coater [manufactured by BUSCHMAN Corporation, trade name “mayer rot HS1.5”], and naturally dried in a thermostat room having a temperature of 23° C. As a result, a birefringent film D in which the refractive index ellipsoid showed the relationship represented by nx>nz>ny was obtained on the glass substrate surface. The properties of the birefringent film D are illustrated in Table 1.

### Example 5

10 g of the 10-methyl-acenaphtho[1,2-b]quinoxaline-9-sulfonic acid obtained in Synthesis Example 7 above were dissolved in 500 ml of ion exchange water. The obtained aqueous solution was neutralized to pH=8 with a 5% aqueous ammonium hydroxide solution. Then, the resultant was condensed to 18% using a rotary evaporator to prepare a coating agent. The coating agent was applied to a 1.3 mm thick glass substrate using a bar coater [manufactured by BUSCHMAN Corporation, trade name “mayer rot HS1.5”], and naturally dried in a thermostat room having a temperature of 23° C. As a result, a birefringent film E in which the refractive index ellipsoid showed the relationship represented by nx>nz>ny was obtained on the glass substrate surface. The properties of the birefringent film E are illustrated in Table 1.

### Example 6

10 g of the 10-methyl-acenaphtho[1,2-b]quinoxaline-9-sulfonic acid obtained in Synthesis Example 7 above were dissolved in 500 ml of ion exchange water. The obtained aqueous solution was neutralized to pH=7 with a 5% aqueous sodium hydroxide solution. Then, the resultant was condensed to 18% using a rotary evaporator to prepare a coating agent. The coating agent was applied to a 1.3 mm thick glass substrate using a bar coater [manufactured by BUSCHMAN Corporation, trade name “mayer rot HS1.5”], and naturally dried in a thermostat room having a temperature of 23° C. As a result, a birefringent film F in which the refractive index ellipsoid showed the relationship represented by nx>nz>ny was obtained on the glass substrate surface. The properties of the birefringent film F are illustrated in Table 1.

### Example 7

10 g of the sulfonated product of N-butyl-9-acenaphtho[1,2-b]quinoxalinecarboxamide obtained in Synthesis Example 9 above were dissolved in 500 ml of ion exchange water. The obtained aqueous solution was neutralized to pH=7 with 5% aqueous ammonium hydroxide solution. Then, the resultant was condensed to 15% using a rotary evaporator to prepare a coating agent. The coating agent was applied to a 1.3 mm thick glass substrate using a bar coater [manufactured by BUSCHMAN Corporation, trade name “mayer rot HS1.5”], and naturally dried in a thermostat room having a temperature of 23° C. As a result, a birefringent film G in which the refractive index ellipsoid showed the relationship represented by nx>nz>ny was obtained on the glass substrate surface. The properties of the birefringent film G are illustrated in Table 1.

TABLE 1

| | | | | Bire- | Bire- | Bire- | Bire- |
|---|---|---|---|---|---|---|---|
| | Bire- | Bire- | Bire- | frin- | frin- | frin- | frin- |
| | frin- | frin- | frin- | gent | gent | gent | gent |
| | gent | gent | gent | film | film | film | film |
| | film A | film B | film C | D | E | F | G |
| Thickness (μm) | 0.4 | 0.4 | 0.6 | 0.6 | 0.4 | 0.4 | 0.4 |
| Δn [590] | 0.3 | 0.3 | 0.24 | 0.24 | 0.39 | 0.35 | 0.25 |
| T [590] (%) | 90 | 90 | 90 | 90 | 91 | 91 | 90 |
| Re [590] (nm) | 120 | 120 | 154 | 152 | 174 | 154 | 103 |
| Rth [590] (nm) | 18 | 64 | 89 | 18 | 26 | 66 | 43 |
| Nz coefficient | 0.15 | 0.53 | 0.58 | 0.12 | 0.15 | 0.43 | 0.41 |
| Re [480]/ | 1.09 | 1.09 | 1.13 | 1.13 | 1.15 | 1.14 | 1.12 |
| Re [550] | | | | | | | |

As shown in examples 1 to 7, by applying a solution containing at least one polycyclic compound containing a —S0₃M group and/or a —COOM group and a solvent onto the surface of a base material, a birefringent film was successfully obtained, in which the refractive index ellipsoid satisfies the relationship represented by nx>nz>ny, and the in-plane birefringent index is high. The birefringent film has considerably reduced thickness as compared with a conventional polymer film-type birefringent film and can exhibit a given retardation value.

### INDUSTRIAL APPLICABILITY

As described above, in the birefringent film of the present invention, the refractive index ellipsoid satisfies the relationship represented by nx>nz>ny, and the in-plane birefringent index is high. Therefore, when used for a liquid crystal display, the birefringent film of the present invention can considerably contribute to improving display properties and reducing the thickness. Moreover, according to the production method of the present invention, a birefringent film having the above-mentioned excellent properties can be obtained merely by applying a solution to a base material even when a special stretching method is not used. Therefore, the production method of the present invention is extremely useful for increasing productivity of the birefringent film.

1. A birefringent film, comprising:
at least one polycyclic compound containing a —SO₃M group and/or a —COOM group having a refractive index ellipsoid satisfying a relationship represented by nx>nz>ny, where M represents a counter ion.

2. A birefringent film according to claim 1, wherein an in-plane birefringent index (Δn[590]) at a wavelength of 590 nm of the birefringent film is 0.05 or more.

3. A birefringent film according to claim 1, wherein a thickness of the birefringent film is 0.05 μm to 10 μm.

4. A birefringent film according to claim 1, wherein the birefringent film comprises an acenaphtho[1,2-b]quinoxaline derivative represented by General Formula (I) shown below: 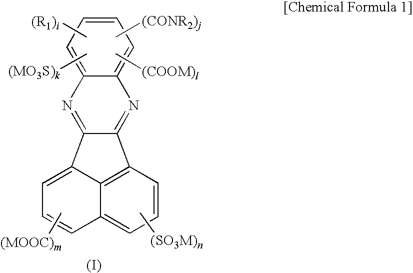
where i, j, k, and l each independently represent an integer of 0 to 4; m and n each independently represent an integer of 0 to 6; R₁ and R₂ each represent a C₁₋₆ alkyl group; M's may be the same or different and each M represent a counter ion; and i, j, k, l, m, and n are not simultaneously 0.

5. A birefringent film according to claim 1, wherein an in-plane retardation value (Re[590]) of the birefringent film at a wavelength of 590 nm is 20 nm to 1000 nm.

6. A birefringent film according to claim 1, wherein a difference between an in-plane retardation value (Re[590]) and a thickness direction retardation value (Rth[590]) of the birefringent film at a wavelength of 590 nm is 10 nm to 800 nm.

7. A birefringent film according to claim 1, wherein an Nz coefficient of the birefringent film is more than 0 and less than 1.

8. A laminated film, having at least a birefringent film according to claim 1 and a base material.

9. A method of producing a birefringent film, comprising the following steps of (1) to (3):
(1) a step of preparing a solution including at least one polycyclic compound containing a —SO₃M group and/or a —COOM group, wherein M represents a counter ion, and a solvent, and showing a nematic liquid crystal phase;
(2) a step of preparing a base material, at least one surface of which has been subjected to a hydrophilization treatment;
(3) a step of applying the solution prepared in the step (1) above onto the surface of the base material prepared in the step (2) above, the surface being subjected to hydrophilization treatment, and drying the base material.

10. A method of producing a birefringent film according to claim 9, wherein the hydrophilization treatment is corona treatment, plasma treatment, alkali treatment, or anchor coat treatment.

11. A method of producing a birefringent film according to claim 9, wherein the base material is a glass substrate or a polymer film.

12. A polarizing plate, having at least a birefringent film according to claim 1 and a polarizer.
